(19) United States
(12) Patent Application Publication
(10) Pub. No.: US 2024/0166935 A1
(43) Pub. Date: May 23, 2024

(54) DRILL-IN FLUIDS USING CALCIUM CARBONATE PARTICLES FORMED FROM SEQUESTERED CARBON DIOXIDE

(71) Applicant: Chevron U.S.A. Inc., San Ramon, CA (US)

(72) Inventor: Sandra Liliana Gomez-Nava, Katy, TX (US)

(21) Appl. No.: 18/056,465

(22) Filed: Nov. 17, 2022

(51) Int. Cl. C09K 8/06

(52) U.S. Cl. CPC C09K 8/06

(57) ABSTRACT

A drill-in fluid composition comprises a base fluid, a viscosifier, a fluid loss control agent, and a blend of calcium carbonate particles having at least two different sizes, wherein at least a portion of the blend of calcium carbonate particles are synthetic calcium carbonate particles formed from captured carbon dioxide. The blend of calcium carbonate particles can include natural calcium carbonate particles. The drill-in fluid composition is used when drilling a well through a formation.

### TECHNICAL FIELD

Embodiments of the technology relate generally to drill-in fluids using calcium carbonate particles formed from sequestered carbon dioxide.

### BACKGROUND

Wells are drilled into land and subsea formations for various purposes, including producer wells that produce resources such as water and hydrocarbons (e.g., petroleum and natural gas), and injector wells used to place fluids (e.g., water, wastewater, carbon dioxide gas, chemicals, hydrocarbons) underground into formations. While a well is being drilled, various types of drilling fluids can be used to facilitate the drilling, to remove cuttings created by the drilling, and to protect the formation surrounding the well. Drilling a well typically involves drilling through upper layers of a formation before reaching the target formation layers (reservoir formations to extract hydrocarbon or formation to inject fluids). Drilling through the target formations (reservoir or injection zones) requires particular care so as not to damage the formation pores. Drill-in fluids are particular types of drilling fluids used during the portion of the drilling passing into the reservoir layers of the formation. Drill-in fluids are compositions that form a filter cake along the face of the formation exposed to the well. The filter cake protects the formation by controlling the invasion of drilling fluid components from flowing into the formation. The filter cake formed by a drill-in fluid is designed to minimize any potential formation damage which may impact the subsequent production of the reservoir fluids or the subsequent injection of fluids into the formation. Improvements to drill-in fluids are described in the following description and attached drawings.

### SUMMARY

In one example embodiment, the present disclosure is generally directed to a method of making a drill-in fluid composition. The method comprises contacting an ammoniated aqueous solution with a carbon dioxide source producing a carbonated ammoniated aqueous solution; contacting the carbonated ammoniated aqueous solution with substrate particles to produce synthetic calcium carbonate particles comprising the substrate particles coated with calcium carbonate; and combining a blend of calcium carbonate particles with a base fluid, a viscosifier, and a fluid loss control agent to produce the drill-in fluid composition. The blend of calcium carbonate particles having at least two sizes, wherein at least a portion of the blend comprises the synthetic calcium carbonate particles, and wherein the blend of calcium carbonate particles has a concentration of 20-140 lb/bbl of the drill-in fluid composition, and more preferably a concentration of 30-40 lb/bbl of the drill-in fluid composition.

The foregoing method can further include one or more of the following aspects. The at least two sizes of the blend of calcium carbonate particles can comprise sizes that are chosen from: very fine, fine, medium, and coarse grades. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles. The substrate particles can be one or more of: a) synthetic calcium carbonate, b) a naturally occurring mineral, and c) a self-degrading polymeric material. The drill-in fluid composition can further comprise a pH control agent, such as one of magnesium oxide, sodium hydroxide, or potassium hydroxide. Additionally, the drill-in fluid composition can further comprise one or more of an oxygen scavenger, a clay inhibitor, a lubricant, a biocide, and one or more additional weighting agents (e.g., barite).

In another example embodiment, the present disclosure is directed to a drill-in fluid composition. The drill-in fluid composition can comprise: a base fluid, a viscosifier, a fluid loss control agent, and a blend of calcium carbonate particles having at least two different sizes, wherein at least a portion of the blend of calcium carbonate particles comprise synthetic calcium carbonate particles formed from captured carbon dioxide, and wherein the blend of calcium carbonate particles has a concentration of 20-140 lb/bbl of the drill-in fluid composition, and more preferably a concentration of 30-40 lb/bbl of the drill-in fluid composition.

The foregoing composition can further comprise one or more of the following aspects. The synthetic calcium carbonate particles can be produced by contacting a carbonated ammoniated aqueous solution with substrate particles. The at least two sizes of the blend of calcium carbonate particles can comprise sizes that are chosen from: very fine, fine, medium, and coarse grades. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles. The substrate particles can be one or more of: a) synthetic calcium carbonate, b) a naturally occurring mineral, and c) a self-degrading polymeric material. The drill-in fluid composition can further comprise one of magnesium oxide, sodium hydroxide, or potassium hydroxide. Additionally, the drill-in fluid composition can further comprise one or more of an oxygen scavenger, a clay inhibitor, a lubricant, a biocide, and one or more additional weighting agents (e.g., barite).

In yet another example embodiment, the present disclosure is directed to a method of protecting a formation during drilling of a well. The method can comprise: forming a blend of calcium carbonate particles produced from captured carbon dioxide, wherein at least a portion of the blend of calcium carbonate particles are synthetic calcium carbonate particles formed from captured carbon dioxide; combining the blend of calcium carbonate particles with a base fluid, a viscosifier, and a fluid loss control agent to produce a drill-in fluid composition, wherein the blend of calcium carbonate particles has a concentration of 20-140 lb/bbl of the drill-in fluid composition, and more preferably a concentration of 30-40 lb/bbl of the drill-in fluid composition; and pumping the drill-in fluid composition into the well to a location adjacent to a reservoir zone of the formation.

The foregoing method can further include one or more of the following aspects. The drill-in fluid composition can form a filter cake on a wellbore face of the formation. The calcium carbonate particles can be produced by contacting a carbonated ammoniated aqueous solution with substrate particles. The substrate particles can be one or more of: a) synthetic calcium carbonate, b) a naturally occurring mineral, and c) a self-degrading polymeric material. In one aspect, the synthetic calcium carbonate particles of the blend of calcium carbonate particles can have a range of sizes. In another aspect, the blend of calcium carbonate particles can comprise natural calcium carbonate particles and the synthetic calcium carbonate particles.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments relating to methods and compositions for drill-in fluids and therefore are not to be considered limiting of the scope of this disclosure. The principles illustrated in the example embodiments of the drawings can be applied to alternate methods and compositions. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1A illustrates a method of producing a drill-in fluid composition comprising synthetic calcium carbonate particles in accordance with an example embodiment of the disclosure.

FIG. 1B illustrates a synthetic calcium carbonate particle produced using the method of FIG. 1A in accordance with an example embodiment of the disclosure.

FIG. 2A illustrates a method of producing a drill-in fluid composition comprising synthetic calcium carbonate particles in accordance with an example embodiment of the disclosure.

FIG. 2B illustrates a synthetic calcium carbonate particle produced using the method of FIG. 2A in accordance with an example embodiment of the disclosure.

FIG. 3 illustrates a well drilled with a drill-in fluid composition in accordance with an example embodiment of the disclosure.

FIG. 4 illustrates a method of drilling a well with a drill-in fluid composition in accordance with an example embodiment of the disclosure.

### DETAILED DESCRIPTION OF EXAMPLE EMBODIMENTS

The example embodiments discussed herein are directed to compositions and methods for forming and using drill-in fluids comprising calcium carbonate particles formed from sequestered carbon dioxide. Conventional calcium carbonate particles are a common bridging and weighting additive used in drill-in fluids. Conventional calcium carbonate particles can form a filter cake along the wellbore face of the formation. The filter cake protects the formation by controlling the invasion of drilling fluid components into the formation. Filter cake formed from drill-in fluids is designed to minimize any potential formation damage which may impact the subsequent production of reservoir fluids or injection of fluids. Once the drilling is completed, the calcium carbonate particles are also advantageous because they can be dissolved and removed with an acid or chemical treatment so that the filter cake does not obstruct production of the resource from the reservoir into the well. Conventional calcium carbonate particles are typically extracted from naturally occurring sources such as limestone, dolomite, and marble natural rock formations. After the naturally occurring calcium carbonate ores are mined, the ores undergo a grinding process to produce calcium carbonate particles of the desired size for use in drill-in fluids. In some cases, the calcium carbonate particles are mixed with other materials to achieve the desired weighting and bridging properties. Alternatives to calcium carbonate particles that have been used in drill-in fluids include rock salt, evaporated salt, soluble resins, and polylactic acid. However, calcium carbonate particles remain as a dominant choice for drill-in fluids.

One disadvantage of using naturally occurring calcium carbonate in drill-in fluids is that the mining and processing of the calcium carbonate is a lengthy process that requires substantial amounts of energy. The mining equipment, transport vehicles, and grinding equipment may use a substantial amount of energy and such use may generate carbon dioxide that is emitted into the atmosphere.

There have been a variety of efforts throughout various industries to reduce the amount of carbon dioxide released into the atmosphere. One method for reducing the amount of carbon dioxide emitted into the atmosphere is to capture carbon dioxide released during various activities and to sequester the carbon dioxide. Sequestered carbon dioxide can be stored using a variety of techniques. One technique involves combining the sequestered carbon dioxide with an aqueous solution to produce calcium carbonate, thereby sequestering the captured carbon dioxide in the produced calcium carbonate. Calcium carbonate produced from sequestered carbon dioxide can be referred to herein as synthetic calcium carbonate to distinguish it from the naturally occurring calcium carbonate that is mined and used the conventional calcium carbonate particles traditionally used in drill-in fluid compositions. New applications that substitute synthetic calcium carbonate containing captured carbon dioxide in place of naturally occurring calcium carbonate provide additional opportunities to reduce the amount of carbon dioxide released into the atmosphere.

The example embodiments described herein can provide applications for replacing the naturally occurring calcium carbonate used in conventional drill-in fluid compositions with synthetic calcium carbonate particles comprising sequestered carbon dioxide. These applications provide multiple advantages. First, the energy used and the associated carbon dioxide emitted in connection with the mining, transporting, and processing of naturally occurring calcium carbonate can be reduced. Replacing a portion of the conventional calcium carbonate raw material with the synthetic calcium carbonate particles reduces the amount of raw material that otherwise must be mined and transported. Thus, reducing the costs and carbon dioxide emissions associated with mining and transporting the large volumes of calcium carbonate provides significant benefits. These benefits can be further maximized when the synthetic calcium carbonate formed from sequestered carbon dioxide can be formed at or near the wells where it is to be used.

Second, carbon dioxide emitted from other processes involving fossil fuel combustion or the carbon dioxide already present in the atmosphere can be captured and sequestered in the synthetic calcium carbonate particles used in drill-in fluid compositions. When the synthetic calcium carbonate particles sequester carbon dioxide from the atmosphere or from a combustion process, the fluid loss control composition locks up carbon dioxide that would otherwise add to the total carbon dioxide in the atmosphere.

Therefore, given the foregoing benefits, using synthetic calcium carbonate particles containing sequestered carbon dioxide in a drill-in fluid during a drilling operation reduces the carbon dioxide emissions that would normally be associated with the hydrocarbon producer wells and injector wells. As will be described further in the following examples, the methods and apparatus described herein improve upon prior art approaches to producing calcium carbonate particles for use in hydrocarbon producer wells and injector wells.

As used herein, the terms “sequestered carbon dioxide” and “captured carbon dioxide” refer to the process of gathering carbon dioxide from the atmosphere or directly from a combustion process, combining the carbon dioxide with an aqueous solution, and producing calcium carbonate that traps the carbon dioxide in a solid compound.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

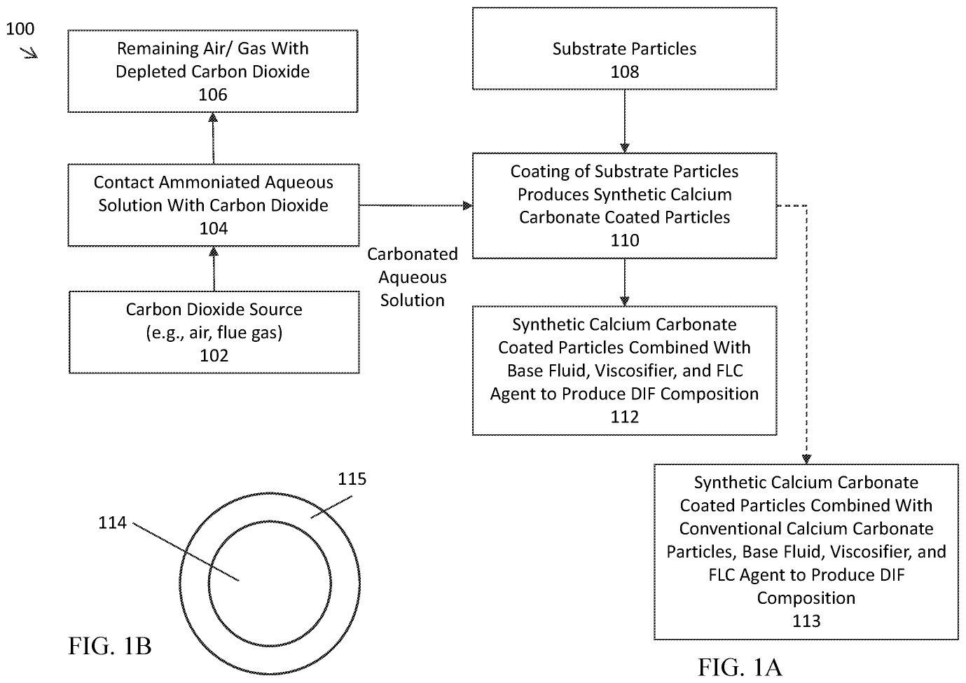

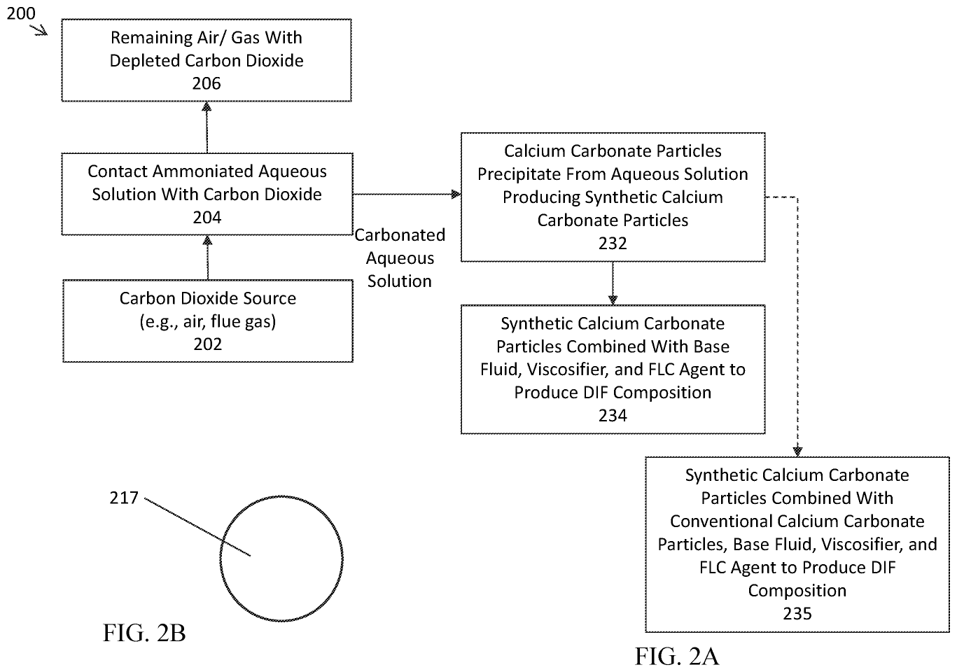

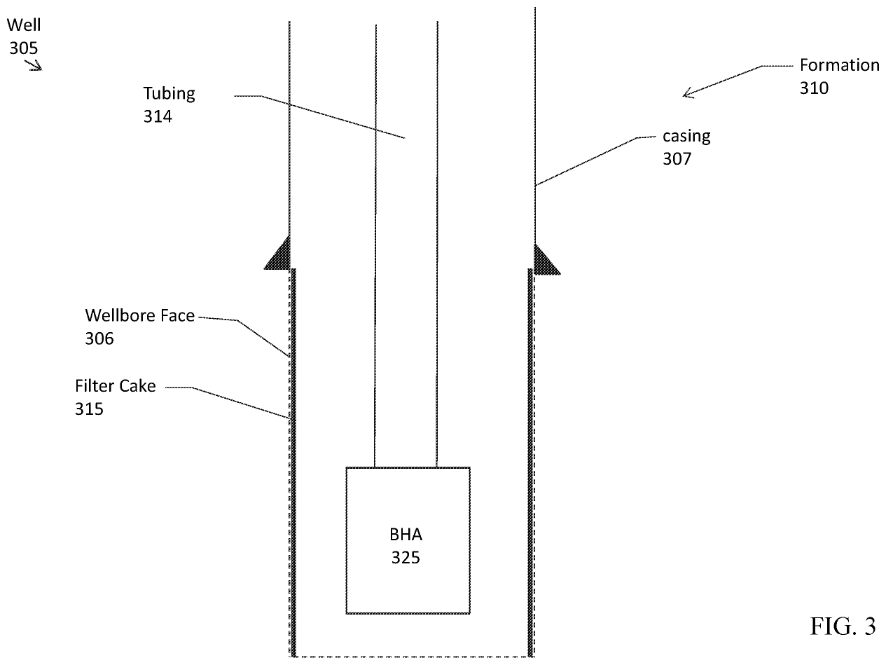

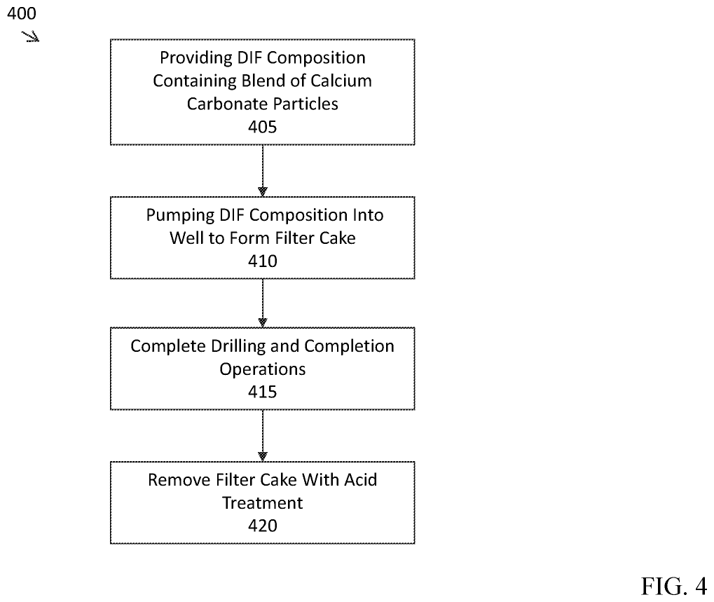

FIGS. 1A and 2A illustrate varying processes for manufacturing a drill-in fluid composition with synthetic calcium carbonate particles that include sequestered carbon dioxide. FIGS. 1B and 2B illustrate the structure of the synthetic calcium carbonate particle produced according to each associated manufacturing process. FIG. 3 illustrates a hydrocarbon well treated with a drill-in fluid composition and FIG. 4 illustrates a method for treating a hydrocarbon well with a drill-in fluid composition in accordance with the example embodiments of this disclosure.

Referring to FIG. 1A, an example method 100 is illustrated for manufacturing a drill-in fluid composition using synthetic calcium carbonate particles. In step 102, a source of carbon dioxide is gathered for use in the method 100. The source of carbon dioxide can be air from the atmosphere or flue gas from the burning of a hydrocarbon.

In step 104, the carbon dioxide is brought into contact with an ammoniated aqueous solution. While the carbon dioxide source in step 102 is typically in gas form such as air or flue gas, it should be understood that the state of the carbon dioxide can be modified for the purpose of contacting with the aqueous solution. For example, the carbon dioxide brought into contact with the ammoniated aqueous solution can be in the state of a gas, a liquid, a solid, or a mixture of one of these states. The carbon dioxide source can be brought into contact with the ammoniated aqueous solution by bubbling carbon dioxide gas through the solution or by mixing solid or liquid forms of the carbon dioxide with the fluid flow of the ammoniated aqueous solution. The carbon dioxide reacts with the ammoniated aqueous solution and produces carbonic acid, bicarbonate ions, and carbonate ions. The presence of calcium ions in the aqueous solution allows for a greater concentration of the carbon dioxide to be sequestered. It should be understood that in alternate embodiments, other divalent cations such as magnesium ions, can be included in the aqueous solution. After the carbon dioxide is contacted with the ammoniated aqueous solution, the remaining carbon dioxide source gas, which has now been depleted of the carbon dioxide absorbed in step 104, is discharged in step 106 having less carbon dioxide than when it was the original source gas in step 102. Thus, step 104 removes carbon dioxide from the carbon dioxide source and discharges a depleted carbon dioxide gas in step 106.

In step 108, substrate particles are gathered for introducing into the carbonated aqueous solution produced in step 104. The substrate particles can be any of a variety of particles that can be used as the base for the synthetic calcium carbonate particles that are to be formed using method 100. The substrate particles should be made from a material that can decompose or be dissolved so that they can be removed after the drilling operation is completed. Examples of substrate particles include, but not limited to a) a naturally occurring mineral such as salt rock, ilmenite, or naturally occurring calcium carbonate; b) synthetic calcium carbonate particles formed previously by a process such as method 100, and c) a self-degrading polymeric material. The substrate particles can be selected based on their size in order for the synthetic calcium carbonate particles produced by method 100 to have a size appropriate for use as a weighting and bridging material in a drill-in fluid composition.

Referring to step 110, the substrate particles are submerged in the aqueous solution containing carbonates from step 104. While the substrate particles are submerged in the aqueous solution, calcium carbonate compositions precipitate and form a coating of calcium carbonate on the exterior of the substrate particles. The precipitation of the calcium carbonate compositions can be controlled in various ways, including, for example, controlling the temperature of the aqueous solution so that it is in the range of 5 to 70 degrees C. In other examples, other properties of the aqueous solution that can be controlled in order to control precipitation include adjusting the pH of the aqueous solution so that it is in the range of 9 to 14. The result of step 110 is a collection of particles consisting of the substrate particles coated with the synthetic calcium carbonate created by process 100.

FIG. 1B provides a cross-sectional illustration of a synthetic calcium carbonate particle produced in step 110. FIG. 1B shows the inner substrate particle 114 and the outer calcium carbonate coating 115. The calcium carbonate forms a hard shell on the substrate particles and traps the carbon dioxide that was absorbed into the aqueous solution as described in connection with step 104. The calcium carbonate shell formed on the substrate particles increases the diameter of the particles. The size of the synthetic calcium carbonate particles can be in a range that is appropriate for use in a drill-in fluid composition.

Referring to step 112 of FIG. 1A, the synthetic calcium carbonate particles produced in step 110 are combined with other materials to produce a drill-in fluid composition. For example, other typical constituents of a drill-in fluid composition that can be combined with the synthetic calcium carbonate particles include a base fluid, a viscosifier, and a fluid loss control agent. In the example of a water-based drill-in fluid, the base fluid can be a brine solution, whereas the viscosifier (e.g., xanthan gum) and fluid loss control agents (e.g., starches) can be polymers. Furthermore, other components can be added to the water-based drill-in fluid composition as appropriate for the particular conditions of a well, including one or more of: an oxygen scavenger (such as sodium sulfite, sodium bisulfite, ammonium bisulfite, sodium dithionite, sodium erythorbate, sodium thiosulfate, hydrazines, hydroxylamines, etc.), a clay inhibitor (such as organic amine salts, potassium chloride, choline chloride, etc.), a lubricant (such as glycol and polyglycol, ethylene glycol, and polypropylene glycol-based, triglyceride and vegetable oil-based, fatty acid and glyceride-based systems), a biocide (such as glutaraldehyde, chlorinated phenols, isothiazolines, etc.), an additional weighting agent (e.g., barite), and a pH control agent (e.g., magnesium oxide, sodium hydroxide, potassium hydroxide). The weighting agent is described as additional because the synthetic calcium carbonate particles also serve as a weighting agent. Examples of concentrations for the constituents of the water-based drill-in fluid composition are provided below.

TABLE 1

| | Typical additive | |
|---|---|---|
| Additive | concentrations | |
| Base fluid (brine) | As required for density | |
| Viscosifier | 0.75-2.0 | lb/bbl |
| Fluid Loss Control Agent | 4.0-8.0 | lb/bbl |
| pH control additive (e.g., Magnesium | 0.5-3.0 | lb/bbl |

| | |
|---|---|
| Oxide, or Sodium or Potassium | |
| Hydroxide) | |
| CaCO3 or CaCO3 blends * | 20-140 lb/bbl (or 30-40 lb/bbl) |

Other additives based on operational conditions

| Oxygen Scavenger | 0.025% vol. (or 1 ppb) | |
|---|---|---|
| Clay Inhibitor | 4.0-8.0 | ppb |
| Lubricant | 2.0-7.0 ppb (or 1-5%) | |
| Biocide | 0.3-1.0 | ppb |

| | |
|---|---|
| Additional weighting agent (e.g., barite) | As required for density |

* Blends of CaCO3 can include two or more CaCO3 grade sizes: Very fine, fine, medium, coarse.

As an alternative, the drill-in fluid produced in step 112 of FIG. 1A can be an oil-based drill-in fluid. As an example, the typical constituents of an oil-based drill-in fluid that can be combined with the synthetic calcium carbonate particles include an oil base fluid, a brine solution, a viscosifier, a fluid loss control agent, an emulsifier (e.g., fatty acids, amides, amino amides and imidazolines), lime, and a wetting agent (e.g., fatty acids, alkyl phosphate esters, imidazolines and amino amides). In the example of an oil-based drill-in fluid, the oil base fluid can be diesel, a synthetic oil, mineral oil, olefin, or paraffin. The viscosifier (e.g., xanthan gum) and fluid loss control agents (e.g., starches) can be polymers. Furthermore, other components can be added to the oil-based drill-in fluid composition as appropriate for the particular conditions of a well, including barite. Examples of concentrations for the constituents of the oil-based drill-in fluid composition are provided below.

TABLE 2

| | Typical additive | |
|---|---|---|
| Additive | concentrations | |
| Base fluid (diesel, synthetic, mineral oil, | 50-90% | vol. |
| olefin, or paraffin) | | |
| CaCl2 brine (for some applications CaBr2 | 10-60% | vol. |
| brine) | | |
| Viscosifier | 4.0-8.0 | lb/bbl |
| Fluid Loss Control Agent | 1.0-3.0 | lb/bbl |
| Emulsifier | 4.0-8.0 | lb/bbl |
| Lime | 5.0-9.0 | lb/bbl |
| Wetting Agent | 3.0-6.0 | lb/bbl |
| CaCO3 or CaCO3 blends* | 30-40 | lb/bbl |

Other additives based on operational conditions

| | |
|---|---|
| Barite | As required for density |

* Blends of CaCO3 can include two or more CaCO3 grade sizes: Very fine, fine, medium, coarse.

It should be understood that the constituents and the concentrations provided in the tables above are non-limiting examples. In other embodiments of this disclosure, the concentrations can be varied or certain of the above-listed constituents can be omitted. As one example, the concentration of the calcium carbonate particles can fall within a broader range of 20-140 lb/bbl of the drill-in fluid composition.

As noted in the tables above, the calcium carbonate particles used in the drill-in fluid composition typically are a blend of particles having different sizes to effectively form a filter cake along the wellbore face of the formation to inhibit fluid flow into the pores of the formation. While not required, a blend of particles having different sizes can be more effective at forming a filter cake to inhibit fluid loss into the pores of the formation. For example, the blend of particles can include coarse particles and very fine particles that combine to form an effective filter cake in the well. The synthetic calcium carbonate particles described herein provide flexibility in the way in which they can be blended and deployed in drill-in fluid compositions.

Each of the grade sizes of the calcium carbonate particles can represent a size range for the particles within that grade. Accordingly, each of the grade sizes is a blend or distribution of particles within a particular size range. Thus, when two different grade sizes of calcium carbonate particles are combined, it is a blend of two blends of particles. The following are typical numeric size ranges corresponding to the grade sizes of the calcium carbonate particles:
Very fine: D50 of 3-8 microns
Fine: D50 of 9-15 microns
Medium: D50 of 16-50 microns
Coarse: D50 of 51-250 microns

As one example, the drill-in fluid compositions described herein can use a blend of conventional (naturally occurring) calcium carbonate particles and synthetic calcium carbonate particles to achieve the desired varying sizes of particles to form an effective filter cake. This example is illustrated by step 113 of FIG. 1A, which is an alterative to step 112. The conventional calcium carbonate particles can be of a very fine or fine size, whereas the synthetic calcium carbonate particles can be of a medium or coarse size. The ratio of conventional calcium carbonate particles to synthetic calcium carbonate particles can be 50%:50%, 60%:40%; 70%:30%; 40%:60%; or 30%:70% by weight, as non-limiting examples.

Alternatively, in another example, the calcium carbonate particles used in the drill-in fluid composition can be exclusively synthetic calcium carbonate particles. Certain of the synthetic calcium carbonate particles can be of a very fine or fine size, whereas others of the synthetic calcium carbonate particles can be of a medium or coarse size. The ratio of smaller synthetic calcium carbonate particles to larger synthetic calcium carbonate particles can be 50%:50%, 60%:40%; 70%:30%; 40%:60%; or 30%:70% by weight, as non-limiting examples.

The drill-in fluid composition produced by method 100 can be used for treating a well as described further in connection with FIGS. 3 and 4. It should be understood that the example method 100 of FIG. 1A can be modified within the scope of this disclosure. For example, certain steps of method 100 may be altered. Moreover, additional steps may be added in sequence or in parallel to the method 100.

Referring now to FIG. 2A, a variation on the method of FIG. 1A is illustrated. Specifically, FIG. 2A illustrates example method 200. Example method 200 begins in the same manner as method 100 of FIG. 1A. Accordingly, it should be understood that steps 202 through 206 of FIG. 2A are substantially identical to steps 102 through 106 of FIG. 1A and the description of those steps applies to method 200 and will not be repeated. Example method 200 differs from example method 100 in that substrate particles are not used for forming the synthetic calcium carbonate particles. Instead, in step 232 calcium carbonate particles precipitate from the aqueous solution and directly form the synthetic calcium carbonate particles. In other words, instead of simply coating a substrate particle, the synthetic calcium carbonate particles produced in step 232 consist of the calcium carbonate that precipitates from the aqueous solution.

FIG. 2B provides a cross-sectional illustration of the synthetic calcium carbonate particle produced in step 232. As illustrated in FIG. 2B, the particle is formed from the calcium carbonate 217 that precipitates from the aqueous solution.

Referring to step 234, the synthetic calcium carbonate particles produced in step 232 are combined with other materials to produce a drill-in fluid composition. For example, other typical constituents of a drill-in fluid composition that can be combined with the synthetic calcium carbonate particles include a base fluid, a viscosifier, and a fluid loss control agent. In the case of a water-based drill-in fluid, the base fluid is a brine solution, whereas the viscosifier and fluid loss control agents can be polymers. Furthermore, other components can be added to the drill-in fluid composition as appropriate for the particular conditions of a well, including, an oxygen scavenger, a clay inhibitor, a lubricant, a biocide, an additional weighting agent (e.g., barite), and a pH control agent (e.g., magnesium oxide, sodium hydroxide, or potassium hydroxide). The example concentrations provided above in Table 1 in connection with step 112 of FIG. 1 can also be used with a water-based drill-in fluid composition produced by method 200. Alternatively, in the case of an oil-based drill-in fluid, the components and concentrations can correspond with the example provided above in association with Table 2. Additionally, the discussion associated with FIG. 1A concerning blends of calcium carbonate particles having different sizes is equally applicable to the embodiment of FIGS. 2A and 2B.

FIG. 2A also illustrates step 235 as an alternative to step 234. In step 235, the synthetic calcium carbonate particles are combined with conventional calcium carbonate particles to form a blend of particles. As one example, the synthetic calcium carbonate particles may have a grade size of fine, whereas the conventional calcium carbonate particles may have a grade size of medium. Step 235 also indicates that other typical constituents of a drill-in fluid composition that can be combined with the blend of synthetic and conventional calcium carbonate particles include a base fluid, a viscosifier, and a fluid loss control agent.

The drill-in fluid composition produced in step 234 can be used for treating a well as described further in connection with FIGS. 3 and 4. It should be understood that the example method 200 of FIG. 2A can be modified within the scope of this disclosure. For example, certain steps of method 200 or the components used in the method 200 may be altered. Moreover, additional steps may be added in sequence or in parallel to the method 200.

FIGS. 3 and 4 illustrate a method for treating a well with a drill-in fluid composition such as the compositions produced by the methods illustrated in FIGS. 1A and 2A. Drill-in fluids can be used during the portion of a drilling operation that passes through the formation containing the resource to be extracted (e.g., oil, natural gas) or the formation where fluids will be placed. The drill-in fluid assists with maintaining the wellbore, removing cuttings, and protecting the wellbore face of the formation. It should be understood that the example drill-in fluid compositions described herein can be applied to drilling operations for a variety of types of wells in a variety of types of formations.

Referring now to FIG. 3, a cross-section of a well 305 is illustrated. Well 305 can be located on land or could be a deepwater well. Well 305 is defined by a wellbore having wellbore face 306 along a formation 310 that comprises a hydrocarbon reservoir (not shown) or a formation where fluids will be placed. The well 305 comprises a casing 307 proximate the well opening, but the portion of the well below the casing 307 is an open hole such that the wellbore face 306 is exposed to the well. The tubing 314 can be a drill string through which drilling fluids are pumped to facilitate the drilling operation. At the end of the drill string is a bottom hole assembly (BHA) 325 comprising the drilling equipment used to drill the well 305.

As the BHA 325 passes through the target formation (reservoir or injection formation), the drilling fluid pumped through the tubing 314 can be modified to be a drill-in fluid specifically designed to protect the formation. The drill-in fluid can be a drill-in fluid composition such as the compositions described in connection with FIGS. 1A and 2A. When injected into the well through the tubing 314, the drill-in fluid comes into contact with the exposed wellbore face 306 and performs a bridging function whereby the calcium carbonate particles create a filter cake 315. The filter cake 315 along the exposed wellbore face 306 protects the formation and inhibits fluid flow into reservoir zone of the formation.

FIG. 4 illustrates an example method 400 for performing a drilling operation in a reservoir zone of a formation using a drill-in fluid composition such as those produced by the example methods of FIGS. 1A and 1B. In step 405, a drill-in fluid composition having a blend of calcium carbonate particles is provided. The blend of calcium carbonate particles includes at least a portion of synthetic calcium carbonate particles as described previously. In step 410, the drill-in fluid composition is pumped into the well in connection with a drilling operation in the target formation. For example, the drill-in fluid composition can be injected into well 305 using tubing 314 so that the drill-in fluid composition contacts the wellbore face 306 along the reservoir zone of the formation 310. The drill-in fluid forms a filter cake 315 along wellbore face 306 that protects the target formation while the drilling proceeds.

With the filter cake in place, the pores of the target formation in the are protected and the drilling operation, as well as a completion operation, can be completed in step 415. Once the drilling and completion operations are finished, in step 420 the filter cake created with the calcium carbonate particles of the drill-in fluid can be removed by applying an acid or other chemical treatment solution. Calcium carbonate can be easily dissolved using an acid, therefore, the synthetic calcium carbonate provides an easy-to-use alternative to conventional (naturally occurring) calcium carbonate. Additionally, if a substrate is used to form the synthetic calcium carbonate particles, a material that can be easily dissolved or degraded is also used for the substrate. It should be understood that method 400 is only one illustrative example and in alternate embodiments certain steps of method 400 may be altered.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one step or component from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method of making a drill-in fluid composition, the method comprising:
contacting an ammoniated aqueous solution with a carbon dioxide producing a carbonated ammoniated aqueous solution, wherein the carbon dioxide is captured from the atmosphere or flue gas;
contacting the carbonated ammoniated aqueous solution with substrate particles to produce synthetic calcium carbonate particles comprising the substrate particles coated with calcium carbonate; and
combining a blend of calcium carbonate particles with a base fluid, a viscosifier, and a fluid loss control agent to produce the drill-in fluid composition, the blend of calcium carbonate particles having at least two sizes, wherein at least a portion of blend of calcium carbonate particles comprises the synthetic calcium carbonate particles, wherein the blend of calcium carbonate particles has a concentration of 20-140 lb/bbl of the drill-in fluid composition.

2. The method of claim 1, wherein the at least two sizes of the blend of calcium carbonate particles comprises sizes that are chosen from: very fine, fine, medium, and coarse grades.

3. The method of claim 1, wherein the synthetic calcium carbonate particles of the blend of calcium carbonate particles have a range of sizes.

4. The method of claim 1, wherein the blend of calcium carbonate particles comprises natural calcium carbonate particles and the synthetic calcium carbonate particles, wherein the natural calcium carbonate particles have a different size relative to the synthetic calcium carbonate particles.

5. The method of claim 1, wherein the substrate particles are one or more of: a) synthetic calcium carbonate, b) a naturally occurring mineral, and c) a self-degrading polymeric material.

6. The method of claim 1, wherein the drill-in fluid composition further comprises one of magnesium oxide, sodium hydroxide, or potassium hydroxide.

7. The method of claim 1, wherein the drill-in fluid composition further comprises one or more of an oxygen scavenger, a clay inhibitor, a lubricant, a biocide, and an additional weighting agent.

8. A drill-in fluid composition comprising:
a base fluid;
a viscosifier;
a fluid loss control agent; and
a blend of calcium carbonate particles having at least two different sizes, wherein at least a portion of the blend of calcium carbonate particles are synthetic calcium carbonate particles formed from carbon dioxide captured from the atmosphere or flue gas, and wherein the blend of calcium carbonate particles has a concentration of 20-140 lb/bbl of the drill-in fluid composition.

9. The drill-in fluid composition of claim 8, wherein the synthetic calcium carbonate particles are produced by contacting a carbonated ammoniated aqueous solution with substrate particles.

10. The drill-in fluid composition of claim 8, wherein the at least two different sizes of the blend of calcium carbonate particles comprises sizes that are chosen from: very fine, fine, medium, and coarse grades.

11. The drill-in fluid composition of claim 8, wherein the synthetic calcium carbonate particles of the blend of calcium carbonate particles have a range of sizes.

12. The drill-in fluid composition of claim 8, wherein the blend of calcium carbonate particles comprises natural calcium carbonate particles and the synthetic calcium carbonate particles, wherein the natural calcium carbonate particles have a different size relative to the synthetic calcium carbonate particles.

13. The drill-in fluid composition of claim 9, wherein the substrate particles are one or more of: a) synthetic calcium carbonate, b) a naturally occurring mineral, and c) a self-degrading polymeric material.

14. The drill-in fluid composition of claim 8, wherein the drill-in fluid composition further comprises one of magnesium oxide, sodium hydroxide, or potassium hydroxide.

15. The drill-in fluid composition of claim 8, wherein the drill-in fluid composition further comprises one or more of an oxygen scavenger, a clay inhibitor, a lubricant, a biocide, and an additional weighting agent.

16. A method of protecting a formation during drilling of a well, the method comprising:
forming a blend of calcium carbonate particles, wherein at least a portion of the blend of calcium carbonate particles are synthetic calcium carbonate particles formed from carbon dioxide captured from the atmosphere or flue gas;
combining the blend of calcium carbonate particles with a base fluid, a viscosifier, and a fluid loss control agent to produce a drill-in fluid composition, wherein the blend of calcium carbonate particles has a concentration of 20-140 lb/bbl of the drill-in fluid composition; and
pumping the drill-in fluid composition into the well to a location adjacent to a reservoir zone of the formation.

17. The method of claim 16, wherein the drill-in fluid composition forms a filter cake on a wellbore face of the formation.

18. The method of claim 16, wherein the calcium carbonate particles are produced by contacting a carbonated ammoniated aqueous solution with substrate particles, wherein the substrate particles comprise a self-degrading polymeric material.

19. The method of claim 16, wherein the synthetic calcium carbonate particles of the blend of calcium carbonate particles have a range of sizes.

20. The method of claim 16, wherein the blend of calcium carbonate particles comprises natural calcium carbonate particles and the synthetic calcium carbonate particles, wherein the natural calcium carbonate particles have a different size relative to the synthetic calcium carbonate particles.
